(19) United States
(12) Patent Application Publication
(10) Pub. No.: US 2006/0090951 A1
(43) Pub. Date: May 4, 2006

(54) Drivetrain for a backhoe loader

(76) Inventor: Billy D. Waits, Harbor Springs, AK (US)

Correspondence Address: LAW OFFICE OF STEVEN B. LEAVITT, 9914 WATERVIEW PARKWAY, ROWLETT, TX, 75089, US

(21) Appl. No.: 10/980,081

(22) Filed: Nov. 3, 2004

(51) Int. Cl. B60K 17/00

(52) U.S. Cl. 180/336

(57) ABSTRACT

The backhoe loader of the present invention allows an operator to move the backhoe loader without having to take the time to turn the seat around or use the backhoe to push the backhoe loader to the desired location. In addition to the standard front controls that are found on every backhoe loader, rear controls similar to the front controls are added. The front and rear controls are connected to a master switch which determines whether the front or rear controls are used to operate the backhoe loader's drivetrain and brake systems.

### BACKGROUND OF THE INVENTION

1. Technical Field

The present invention relates to the field of drivetrains for heavy machinery, and more particularly to the area of a drivetrain for a backhoe loader.

2. Description of Related Art

Backhoe loaders, commonly called backhoes, have been in existence since at least the 1960's. They are used to dig ditches to lay pipes and underground cable, set up foundations for buildings, create drainage systems, and the like. One of the most common applications for a backhoe loader is the basic job of digging a trench with the backhoe and then back-filling it with the loader.

A backhoe loader is an interesting machine because it is actually three pieces of construction equipment combined into a single unit: a backhoe, a loader and a tractor. Each piece of equipment is suited to a particular sort of work.

The core structure of a backhoe loader is the tractor. Similar to tractors used in farming, the backhoe tractor is designed to move easily over numerous types of terrain from rough to smooth and/or muddy to dry. Employed are a powerful diesel engine, large rugged tires, and a cab with basic steering controls (a steering wheel, brakes, etc.) located in the front cab of the backhoe loader. The tractor component is used for moving the other two components from place to place. The operator also maneuvers it when using the loader.

The loader component is attached at the front end of the backhoe loader. The loader can do several different things. In many applications, it is used like a big, powerful dustpan or coffee scoop. The loader is mostly used to pick up and carry large amounts of loose material. It is also used to smooth things over like a butter knife or to push dirt like a plow. The operator controls the loader while driving the tractor with controls located in the front end of the backhoe loader.

The backhoe is the main tool of the backhoe loader and is attached to the back end of the machine. It is used to dig up hard, compact material, usually earth, or to lift heavy loads, such as a sewer box. Basically, the backhoe has three segments: the boom, stick, and bucket. The backhoe is especially suited for digging ditches for sewer and utility lines, digging foundations, and grading. In using the backhoe, the operator parks the tractor and turns the seat around to face the back end. Backhoe loaders are atypical in that during operation the operator will turn completely around and face the rear of the machine away from the driving controls.

When operating the backhoe loader, the operator selects whether the tractor and/or loader will be used or whether the backhoe will be used. If the backhoe is to be used, then a disk mounted in the front of the rear axle locks the input shaft from the transmission to prevent the backhoe loader from moving forward or in reverse.

Because the boom, stick, and bucket have a finite length, the backhoe can only dig in a relatively limited area. Therefore, when an operator is using the backhoe to dig a relatively large area, for example a foundation, the backhoe loader must be moved after only a portion of the area is dug out. To move the backhoe loader, the operator must turn the seat around to the front and drive the tractor to the desired location, often only a few feet away.

Because this process is time consuming, most operators will use the backhoe to push the tractor to the new location. This process is undesirable because the force of the backhoe pushing into the ground will leave the surface uneven and often unusable for the task the backhoe was performing. In addition, such a process can be harmful to the backhoe loader.

Therefore, it is desirable to be able to move the backhoe loader without having to take the time to turn the seat around or use the backhoe to push the backhoe loader to the desired location. It would be preferable if an existing backhoe loader could quickly modified in a cost effective manner without taking away any of the functions of the backhoe loader.

### SUMMARY OF THE INVENTION

The backhoe loader of the present invention allows an operator to move the backhoe loader without having to take the time to turn the seat around or use the backhoe to push the backhoe loader to the desired location. This is achieved by adding rear controls similar to the front controls that are found on every backhoe loader. The front and rear controls are connected to a master switch which determines whether the forward or the rearward controls are used to operate the backhoe loader's drivetrain and braking system.

The master switch is connected to the electrical solenoids for the drivetrain shuttle that controls the transmission on the backhoe loader as well as being connected to the backhoe's hydraulic braking system.

The rearward controls can be quickly and easily installed on an existing backhoe loader. By adding the rearward controls, an operator can move the backhoe loader to a desired location without having to turn the seat around or use the backhoe to push the backhoe loader to the desired location.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a planar side view of a backhoe fitted with a modified drivetrain in accordance with the present invention;

FIG. 2 is a cross sectional schematic view of the backhoe of FIG. 1;

FIG. 3 is a planar view of a master switch in accordance with the present invention for use in the backhoe of FIG. 1; and

FIG. 4 is a cross sectional schematic view of a second embodiment of a backhoe fitted with a modified drivetrain in accordance with the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

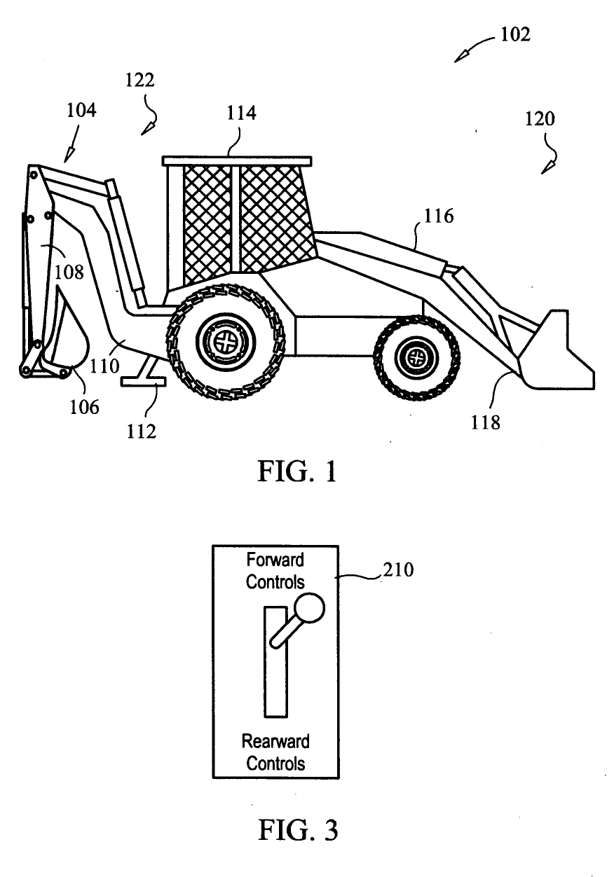

FIG. 1 shows a typical backhoe loader 102 using a powertrain and having loader 118, tractor 116, backhoe 104 and stabilizer legs 112. For example purposes, the backhoe loader 102 is based on a Caterpillar® 420D model. The powertrain is a CATO powertrain.

At front 120 of backhoe loader 102 is loader 118. At back 122 of backhoe loader 102 are stabilizer legs 112 and backhoe 104. Backhoe 104 comprises bucket 106, stick 108, and boom 110. In between back 122 and front 120 is operating station 114 and tractor 116. Inside tractor 116 is the transmission used to drive and position backhoe loader 102. The transmission is controlled by controls inside operating station 114.

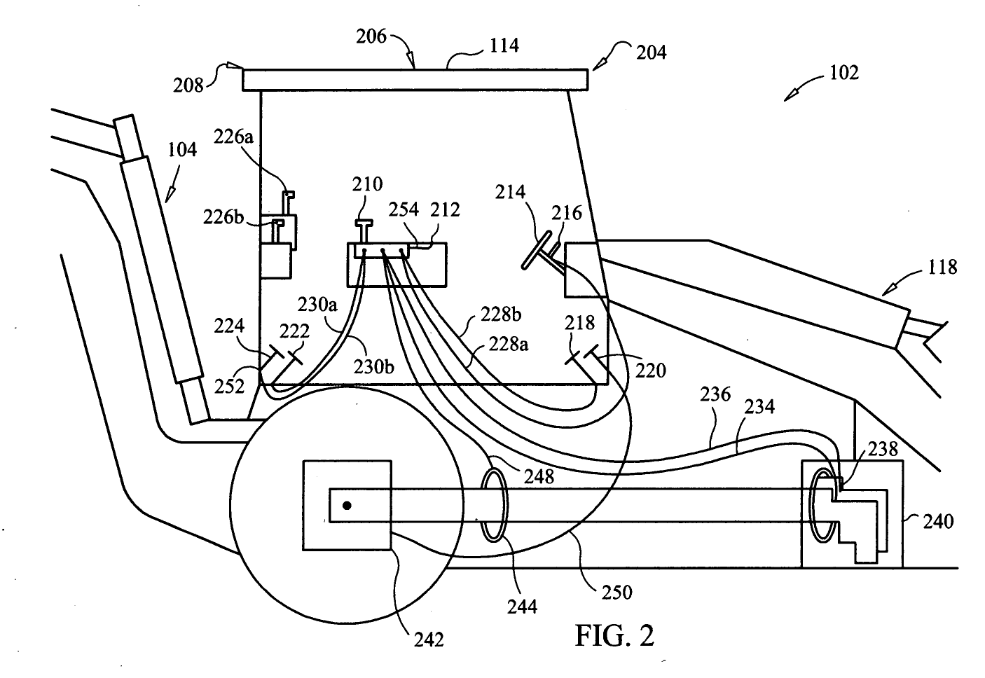

FIG. 2 is a side view of inside of inside operating station 114. Operating station 114 can be divided into three portions: forward portion 204, middle portion 206, and rearward portion 208. Forward portion 204 is provided for use when backhoe loader 102 is driven or loader 118 is operated. Rearward portion 208 is used when operating the backhoe 104.

Middle portion 206 contains the seat, gauges and controls. The gauges provide information such as the fuel level and oil temperature. The controls include, among other known controls, cutoff switch 212 and master switch 210. Cutoff switch 212 is a safety switch and prevents backhoe loader 102 from being controlled from the controls in rearward portion 208. Cutoff switch 212 is operationally connected to master switch 210 via electrical wire 234 and, if set to a disengage position, will prevent the controls in rearward portion 208 from controlling backhoe loader 102.

Master switch 210 determines if the controls at forward portion 204 control the transmission, or if the controls at rearward portion 208 control the transmission and braking system. FIG. 3 is a picture of master switch 210 wherein the controls in forward portion 204 will be used.

Referring again to FIG. 2, forward portion 204 contains steering wheel 214, control lever 216, accelerator pedal 218 and brake pedal 220. To operate backhoe loader 102 using the controls located in forward position 204, master switch 210 is moved to the forward portion controls position (See FIG. 3), the stabilizer legs 112, if lowered, are raised, and control lever 216 is set to either forward/drive position or reverse position.

When control lever 216 is set to the forward/drive position, a signal is sent to master switch 210 via forward control wire 228a. If the position of master switch 210 is in the forward controls position, the signal is transmitted to electrical solenoid 238 via primary forward control wire 234 and transmission 240 of backhoe loader 102 is set for forward motion. If the position of master switch 210 is in the rearward controls position, then the signal is not transmitted to electrical solenoid 238.

When control lever 216 is set to the reverse position, a signal is sent to master switch 210 via forward control wire 228a. If the position of master switch 210 is in the forward controls position, the signal is transmitted to electrical solenoid 238 via primary reverse control wire 236 and transmission 240 of backhoe loader 102 is set for reverse or rearward motion. If the position of master switch 210 is in the rearward controls position, then the signal is not transmitted to electrical solenoid 238.

Master switch 210 is operationally connected to backhoe loader's 102 electrical solenoid 238 via primary forward control wire 234 and primary reverse control wire 236. Electrical solenoid 238 controls backhoe loader's 102 transmission 240.

As is known in the art, electrical solenoid 238 is an electrically operated, magnetic switching device which controls hydraulic circuits in the transmission by controlling a flow of pressurized hydraulic fluid. A plunger inside electrical solenoid 238 is spring loaded to the closed position and when energized, the plunger is pulled up to allow pressurized hydraulic fluid to flow.

If backhoe loader 102 is to be moved forward, then control lever 216 is moved to the forward position and accelerator pedal 218 is pressed to give backhoe loader 102 forward momentum. If backhoe loader 102 is to be moved in reverse, control lever 216 is moved to the reverse position and accelerator pedal 218 is pressed to give backhoe loader 102 reverse or backward momentum.

When accelerator pedal 218 is pressed, a signal is sent to master switch 210 via control wire 228b. If the position of master switch 210 is in the forward controls position, the signal is transmitted to transmission 240 and backhoe loader 102 is accelerated in the forward or reverse direction depending on the position of control lever 216. If the position of master switch 210 is in the rearward controls position, then the signal is not transmitted to transmission 240. Direction is controlled by steering wheel 214. The brakes are controlled with brake pedal 220.

Brake pedal 220 may be a split brake pedal wherein pressing the left partition of brake pedal 220 engages braking system 242 on the left wheel and pressing the right partition of brake pedal 220 engages braking system 242 on the right wheel. If both partitions on brake pedal 220 are pressed equally, then the braking system on the right and left wheel are equally engaged to provide even deceleration. The braking systems on the right and left wheels are hydraulically controlled as is known in the art.

When brake pedal 220 is activated, hydraulic fluid is pumped into a caliper in brake system 242 via hydraulic line 250. The pumped hydraulic fluid causes a piston in the caliper to press against the brake rotor. The friction from the piston in the caliper pressing against the brake rotor slows the rotation of the tire and the movement of backhoe loader 102.

To control backhoe loader 102 using the controls in rearward position 208, master switch 210 is moved to the rear portion controls position (See FIG. 3) the stabilizer legs 112, if lowered, are raised and axle brake 244 locks the input shaft from engaging with the transmission. Rearward portion 208 contains backhoe controllers 226a and 226b, forward accelerator 222 and reverse accelerator 224.

If backhoe loader 102 is to be moved forward, then forward accelerator 222 is activated to give the backhoe loader 102 forward momentum. When forward accelerator 222 is activated, an electrical signal is sent from forward accelerator 222 to master switch 210 via electrical wire 230a. If the position of master switch 210 is in the rearward controls position, the signal is transmitted to electrical solenoid 238 via primary forward control wire 234. Also, master switch 210, via electrical wire 248, sends a signal to axle brake 244 to release the lock on the input shaft thereby allowing the transmission to engage the input shaft and rotate the tires to provide forward momentum for backhoe loader 102.

As soon as forward accelerator 222 is deactivated, axle brake 244 locks the input shaft from the transmission. If the position of master switch 210 is in the forward controls position, then the signal is not transmitted to electrical solenoid 238 or to axle brake 244. Also, if cutoff switch 212 is set to the disengage position, then the signal is not transmitted to electrical solenoid 238 or to axle brake 244.

If backhoe loader 102 is to be moved backward, then reverse accelerator 224 is activated to give the backhoe loader reverse or backward momentum. When reverse accelerator 224 is activated, an electrical signal is sent from reverse accelerator 224 to master switch 210 via electrical wire 230b. If the position of master switch 210 is in the rearward controls position, the signal is transmitted to electrical solenoid 238 via primary reverse control wire 236. Also, master switch 210, via electrical wire 248, sends a signal to axle brake 244 to release the lock on the input shaft thereby allowing the transmission to engage the input shaft and rotate the tires to provide rearward momentum for backhoe loader 102.

As soon as reverse accelerator 224 is deactivated, axle brake 244 locks the input shaft from the transmission. If the position of master switch 210 is in the forward controls position, then the signal is not transmitted to electrical solenoid 238 or to axle brake 244. Also, if cutoff switch 212 is set to the disengage position, then the signal is not transmitted to electrical solenoid 238 or to axle brake 244.

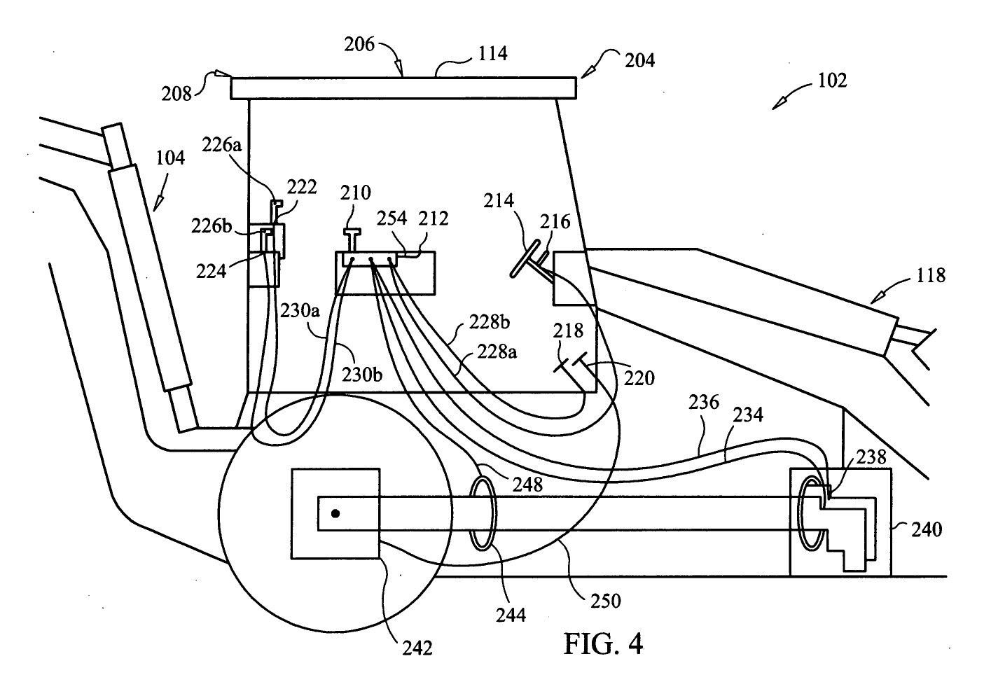

In another embodiment shown in FIG. 4, forward accelerator 222 and reverse accelerator 224 are located on backhoe controllers 226a and 226b respectively and can be activated by the fingers of an operator. This is unlike the forward accelerator 222 and reverse accelerator 224 that are located on the floorboard of backhoe loader 102 of the backhoe loader 102 shown in FIG. 2. Also, forward accelerator 222 and reverse accelerator 224 in FIG. 4 may be located on the side of backhoe controllers 226a and 226b respectively such that they may be activated by pressure from a knee or leg of an operator. Additional locations for the forward and reverse accelerator will be apparent to persons of ordinary skill in the art.

By using forward accelerator 222 and reverse accelerator 224 the backhoe loader 102 can be moved without having to turn the operator's seat around and use the controls in the forward portion 204 or use the backhoe 104 to push the backhoe loader 102.

By having forward and reverse controls at the rear portion 208 of the backhoe loader 102, the backhoe loader 102 can be moved without having to turn the seat around or use the backhoe to push the backhoe loader to the desired location.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims. For example, the invention could be applied to other backhoe loaders other than the one described in the detailed description.

What is claimed is:

1. A backhoe loader having a cab, the backhoe loader comprising:
a transmission for controlling the directional motion of the backhoe loader;
a braking system;
forward controls for controlling the directional motion of the backhoe loader;
rearward controls for controlling the directional motion of the backhoe loader; and
a master switch operationally connected to the transmission, forward controls, and rearward controls.

2. The backhoe loader of claim 1 wherein the master switch determines if the forward controls control the transmission or the rearward controls control the transmission.

3. The backhoe loader of claim 1 further comprising a cutoff switch preventing the rearward controls from controlling the directional motion of the backhoe loader.

4. The backhoe loader of claim 1 wherein the master switch is operationally connected to an axle brake.

5. The backhoe loader of claim 1 wherein the master switch is operationally connected to an electrical solenoid in the transmission.

6. The backhoe loader of claim 1 wherein the master switch is located in the middle of the cab on the backhoe loader.

7. The backhoe loader of claim 1 wherein the backhoe loader is a rubber tire backhoe loader.

8. A backhoe loader having a cab with a floorboard and controls for operating a backhoe on the backhoe loader, wherein the backhoe loader comprises:
a master switch;
forward controls operationally connected to the master switch;
rearward controls operationally connected to the master switch;
a transmission operationally connected to the master switch; and
a brake system operationally connected to the master switch.

9. The backhoe loader of claim 8 wherein the rearward controls are on the floorboard of the backhoe loader.

10. The backhoe loader of claim 8 wherein the rearward controls are on the controls for operating the backhoe.

11. The backhoe loader of claim 8 wherein the master switch is operationally connected to an electrical solenoid in the transmission.

12. The backhoe loader of claim 8 wherein the master switch is located in the middle of the cab on the backhoe loader.

13. The backhoe loader of claim 8 wherein the backhoe loader is a rubber tire backhoe loader.

14. The backhoe loader of claim 8 wherein the master switch determines if the forward controls control the transmission or the rearward controls control the transmission.

15. A method for repositioning a backhoe loader while operating the backhoe, the method comprising the steps of:
operating the backhoe;
selecting a desired location to position the backhoe loader;
using rearward controls to move the backhoe loader to the desired location wherein the rearward controls are operationally connected to a master switch and the master switch is operationally connected to the transmission of the backhoe loader.

16. The method of claim 15 wherein the master switch is operationally connected to an axle brake.

17. The method of claim 15 wherein the master switch is operationally connected to an electrical solenoid in the transmission.

18. The method of claim 15 wherein the master switch is located in the middle of a cab on the backhoe loader.

19. The method of claim 15 wherein the backhoe loader is a rubber tire backhoe loader.

20. The method of claim 15 wherein the backhoe loader also contains forward controls which are operationally connected to the master switch.
